(19) United States
(12) Patent Application Publication
(10) Pub. No.: US 2020/0327627 A1
(43) Pub. Date: Oct. 15, 2020

(54) METHODS AND SYSTEMS OF A BLOCKCHAIN FOR DISTRIBUTED-ENERGY-PROJECT MANAGEMENT

(71) Applicants: Deep Chakraborty, dublin, CA (US); Jyoti Jain, fremont, CA (US)

(72) Inventors: Deep Chakraborty, dublin, CA (US); Jyoti Jain, fremont, CA (US)

(21) Appl. No.: 16/808,347

(22) Filed: Mar. 3, 2020

Related U.S. Application Data
(60) Provisional application No. 62/813,112, filed on Mar. 3, 2019.

(51) Int. Cl. G06Q 50/06; G06F 16/27; G06Q 20/38; G06Q 30/02

(52) U.S. Cl. CPC G06Q 50/06; G06F 16/27; G06Q 2220/10; G06Q 30/0234; G06Q 20/3827; G06Q 20/389

(57) ABSTRACT

In one aspect, a computerized method for implementing distributed-energy-project blockchain transactions includes the step of providing a distributed-energy-project blockchain, wherein the distributed-energy-project blockchain records. The method includes the step of, with the distributed-energy-project blockchain, recording that an Engineering Design, Hardware Procurement and Construction (EPC) provider entity is paid by a financier upon installing the distributed energy system and has provided a proof of asset performance. The method includes the step of, with the distributed-energy-project blockchain, recording that the financier is paid by an owner a pecuniary equivalent to energy generated by the distributed energy system. The method includes the step of, with the distributed-energy-project blockchain, recording that an operation and maintenance (O&M) provider is paid by the financier for maintaining and providing a proof of performance of the distributed energy system. The method includes the step of, with the distributed-energy-project blockchain, recording that owner pays a utility provider for electricity used by the utility. The method includes the step of, with the distributed-energy-project blockchain, recording that the utility provider provides a rebate to the owner.

### CLAIM OF PRIORITY

This application claims priority to U.S. Provisional Application No. 62/813,112 filed on 3 Mar. 2019 and titled METHODS AND SYSTEMS OF A BLOCKCHAIN FOR DISTRIBUTED-ENERGY-PROJECT MANAGEMENT. This application is incorporated by reference in its entirety.

### BACKGROUND

Currently, project management for distributed energy systems are inefficient, non-transparent and manual. For example, up to seven stakeholders engage in one on one contracts using siloed data over the lifetime of a project that can span up to thirty years. There is no single repository of transaction data on the asset. The history of the asset transactions is not easily available since it is spread across the Engineering Design, Hardware Procurement and Construction (EPC), Owner, Financier and the operations and management (O&M) provider.

These projects often change hands through portfolio acquisition and are thus difficult to evaluate due to lack of transparency in pre-build design, as built designs, hardware specifications, system performance data and maintenance data. Data may be handed over as a combination of paper contracts, design documents, hardware warranty and asset performance reports. A number of transactions rely on manual reporting and a variety of tools insinuating lack of trust between the parties. Accordingly, improvements to implementing and storing distributed-energy-project transactions are desired.

### SUMMARY OF THE INVENTION

In one aspect, a computerized method for implementing distributed-energy-project blockchain transactions includes the step of providing a distributed-energy-project blockchain, wherein the distributed-energy-project blockchain records. The method includes the step of, with the distributed-energy-project blockchain, recording that an Engineering Design, Hardware Procurement and Construction (EPC) entity is paid by a financier upon installing the distributed energy system and has provided a proof of asset performance. The method includes the step of, with the distributed-energy-project blockchain, recording that the financier is paid by an owner a pecuniary equivalent to energy generated by the distributed energy system. The method includes the step of, with the distributed-energy-project blockchain, recording that an operation and maintenance (O&M) provider is paid by the financier for maintaining and providing a proof of performance of the distributed energy system. The method includes the step of, with the distributed-energy-project blockchain, recording that owner pays a utility provider for electricity used by the utility. The method includes the step of, with the distributed-energy-project blockchain, recording that the utility provider provides a rebate to the owner.

In another aspect, a computerized method for implementing distributed-energy-project blockchain smart contracts includes the step of providing a distributed-energy-project blockchain, wherein the distributed-energy-project blockchain records a set of smart contracts, wherein the set of smart contracts include a first smart contract between an Engineering Design, Hardware Procurement and Construction (EPC) and financier of a distributed energy system and a second smart contract between an operation and maintenance (O&M) provider and the financier. The method includes the step of determining that EPC has proven via the distributed-energy-project blockchain that the distributed energy system is generating expected energy in a within a range of acceptable performance. The method includes the step of determining, via the distributed-energy-project blockchain, that a financier distributed energy system has paid the EPC, wherein the payment is automated by verifying the generated energy data from the distributed-energy-project blockchain.

### BRIEF DESCRIPTION OF THE DRAWINGS

FIG. 1 illustrates an example process for implementing a blockchain system for distributed-energy-project management, according to some embodiments.

FIG. 2 illustrates an example process wherein a distributed-energy-project provides several benefits when implemented with a blockchain, according to some embodiments.

FIG. 3 illustrates an example system for implementing a distributed-energy-project blockchain, according to some embodiments.

FIG. 4 illustrates an example process for obtaining project data and sources, according to some embodiments.

FIG. 5 illustrates an example process for implementing distributed-energy-project blockchain transactions, according to some embodiments.

FIG. 6 illustrates an example process for implementing distributed-energy-project blockchain smart contracts, according to some embodiments.

The Figures described above are a representative set and are not an exhaustive with respect to embodying the invention.

### DESCRIPTION

Disclosed are a system, method, and article of manufacture of a blockchain for distributed-energy-project management. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Blockchain can be a growing list of records, called blocks, which are linked using cryptography. Each block contains a cryptographic hash of the previous block, a timestamp, and transaction data (e.g. represented as a Merkle-tree root hash).

Power purchase agreement (PPA) can be a contract for the purchase of electrical energy.

Smart contract is a computer protocol intended to digitally facilitate, verify, or enforce the negotiation or performance of a contract. Smart contracts allow the performance of credible transactions without third parties. These transactions can be trackable and irreversible.

### Example Methods

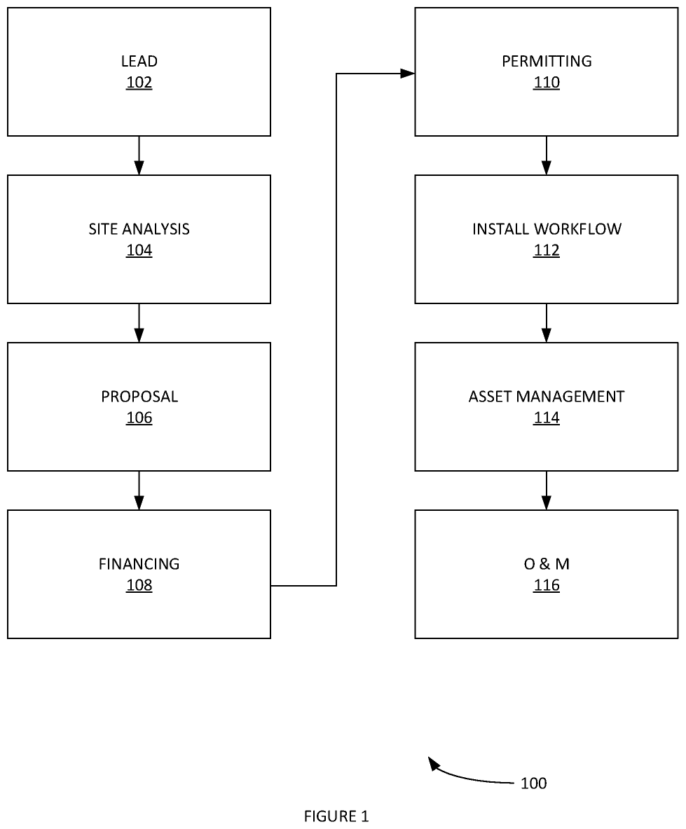

FIG. 1 illustrates an example process 100 for implementing a blockchain system for distributed-energy-project management, according to some embodiments. Process 100 can govern and drive an entire distributed-energy-project through its life cycle. The lifecycle of such a project includes the following stages provided by steps 102-116.

The blockchain system of process 100 can provide an understanding of the entire expected lifecycle. Process 100 can drive the data acquisition, data storage, data access rules, transactions between different parties and adherence to build in smart contracts between the stakeholders. Process 100 can manage a blockchain system that is reliable and trustworthy for every entity involved and would be the single source of truth throughout the project's lifecycle. In provided scheme, process 100 can manage a blockchain system that is the master for driving a distributed-energy-project and not one of the project stakeholders.

More specifically, process 100 include a lead generation step 102. Based on the lead, process 100 implements site analysis 104. The information from steps 102 and 104 can be used to generate a distributed-energy-project proposal in step 106. Financing 108 and permitting 110 can then be implemented. Once completed, process 100 can move forward to installation in step 112. In step 114, process 100 can maintain asset management 114 for the distributed-energy-project. Step 114 can be repeated periodically and/or on an as-need basis. In step 116, process 100 can obtain observations and measurements of the specified distributed-energy-project.

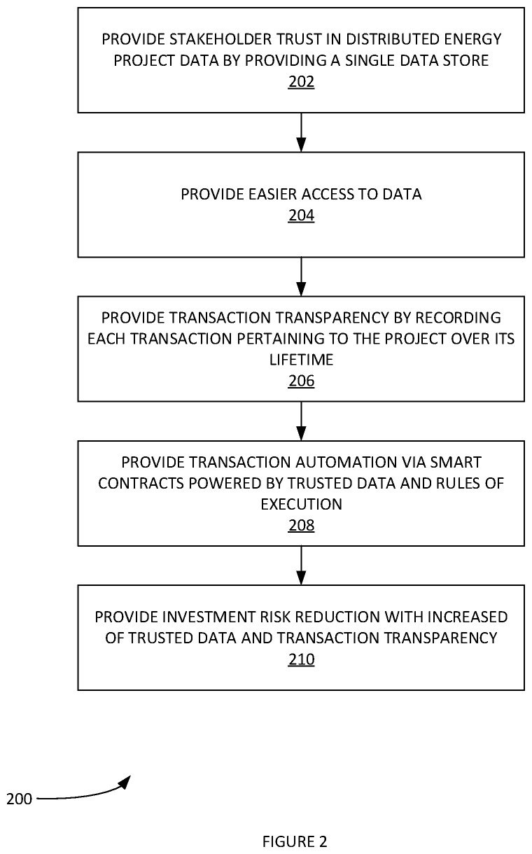

It is noted that the distributed-energy-project can be a solar energy project. FIG. 2 illustrates an example process 200 wherein a distributed-energy-project provides several benefits when implemented with a blockchain, according to some embodiments. In step 202, a blockchain system can provide stakeholder trust in distributed-energy-project data by providing a Data Store. The Data Store can be immutable without the approval of predefined stakeholders.

In step 204, the distributed-energy-project blockchain system can provide easier access to data. This can be based on stakeholder roles including, inter alia: the read or write authorization.

In step 206, the distributed-energy-project blockchain system can provide transaction transparency by recording each transaction pertaining to the project over its lifetime. In step 208, the distributed-energy-project blockchain system can provide transaction automation. This can be implemented via smart contracts powered by trusted data and rules of execution. In step 210, process 100 can provide investment risk reduction. In this way, process 200 can enable increased of trusted data and transaction transparency. This can lead to reduce risk of investment in the solar project as all parties can have the visibility to the project financial performance as designed and as built.

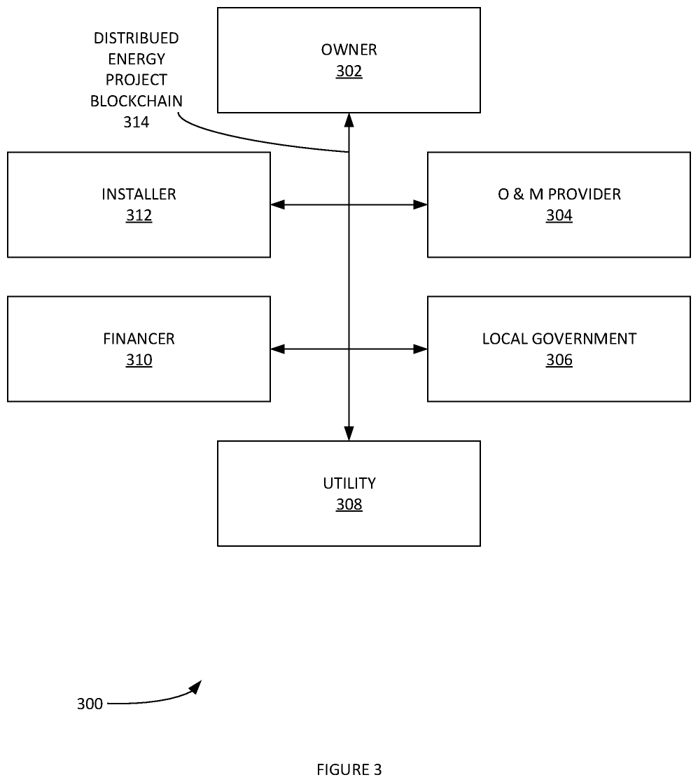

FIG. 3 illustrates an example system 300 for implementing a distributed-energy-project blockchain, according to some embodiments. System 300 provides example stakeholders in the distributed-energy-project blockchain system. System 300 can be used as an example definition of a distributed-energy-project blockchain stakeholders. System 300 includes a distributed-energy-project blockchain 314.

Distributed-energy-project blockchain 314 can be utilized by stakeholders 312. Installer 312 can be an Engineering Design, Hardware Procurement and Construction (EPC) entity. EPC entity can implement engineering design, hardware procurement and construction of the distributed-energy-project. Owner 302 can own the distributed-energy-project. Owner 302 can use the energy generated by the project. Financier 310 can finance the project either as a loan, a lease or a PPA. O&M provider 302 can operate and maintain the project for the contract term. Utility provider 308 can provide the remaining energy used by the owner's facility. Utility provider 308 can bill the owner for that energy and accounts for the net metered energy (e.g. in terms of energy delivered/surplus energy injected into the power grid). Local government 306 can issue the permit to operate the system and pays incentives to build/operate the system.

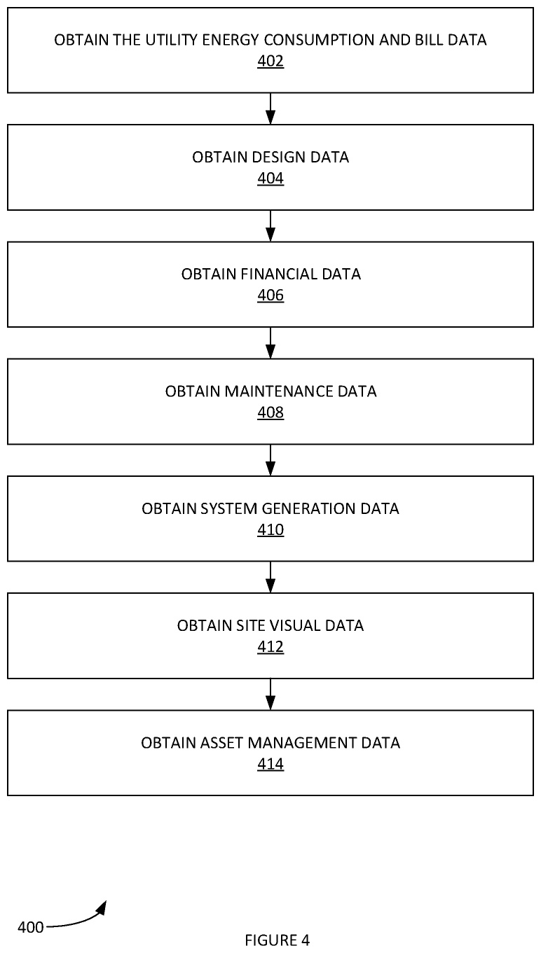

FIG. 4 illustrates an example process 400 for obtaining Project Data and Sources, according to some embodiments. In step 402, process 400 can obtain the utility energy consumption and bill data. This can include pre-installation utility bills (e.g. KW/h and dollars values) for the meters that offset utility energy consumption with energy generation). This can include post-install Utility bill (e.g. KW/h and dollars values) for the meters that offset utility energy consumption with energy generation. This can include pre-installation utility rate structures. This can include post-installation utility rate structures.

In step 404, process 400 can obtain design data. This can include solar panel, energy storage and inverter layouts, hardware specifications, system electrical diagrams, structural designs, system generation estimates with assumed solar irradiation and weather conditions, energy storage system configuration with charge and discharge rules, and/or assumptions such as panel degradation over time, system losses due to wiring, shading, soiling, snow, DC/AC conversion.

In step 406, process 400 can obtain financial data. This can include the cost of hardware (e.g. estimated and actual); the cost of installation (e.g. estimated and actual); the cost of permits (e.g. estimated and actual); the cost of design and engineering (e.g. estimated and actual; financing costs (e.g. estimated and actual); government and/or state incentives (e.g. including tax benefits, estimated and actual, etc.); financing structure and estimated finance payments and actual payments over the life of the project; O&M costs (e.g. estimated and actual); asset management costs; (e.g. estimated and actual); savings from owner's perspective (e.g. estimated and actual); asset depreciation (e.g. estimated and actual); e.g. value of generated energy with minimum monthly granularity (e.g. estimated and actual); etc.

In step 408, process 400 can obtain maintenance data. Maintenance data can include records of planned and unplanned maintenance events. These can include, inter alia: date-time of occurrence, description of event, hardware impact, duration of the event, generation impact, financial impact, cost of repair (e.g. if outside the recurring O&M payment), resolution description, handling personnel and company, etc. Maintenance data can include hardware swaps. Hardware swaps can include, inter alia; old hardware make, model and serial number; new hardware make, model and serial number; location of the hardware in the layout; reason for swap; old hardware warranty period; new hardware warranty period; old hardware datasheet; new hardware datasheet; etc.

In step 410, process 400 can obtain system generation data. System generation data can include inverter and system level generation in KW/h with minimum hourly granularity (e.g. since System Startup Date, etc.). System generation data can include inverter and system level generation in KW with minimum hourly granularity since system startup date. System generation data can include energy storage system charge and discharge data of minimum hourly granularity. System generation data can include system alerts issued by the hardware and by the monitoring system on site. System generation data can include solar irradiance data for the location if available through onsite weather station with minimum hourly granularity since system startup date.

In step 412, process 400 can obtain site visual data. Site visual data can include, inter alia: site pictures/videos before the project is built; site pictures/videos during the project installation; site pictures through drones/on-site cameras or satellite through the life of the project.

In step 414, process 400 can obtain asset management data. Asset management data can include, inter alia: monthly and annual reports on asset performance; asset O&M Contract length and terms; asset cash flows; etc.

Process 400 can implement the following example rules of data access. Project Generation data can be accessible by all parties for viewing only. Project O&M events data can be accessible by all parties for viewing and not alterable after ninety (90) days of event resolution. Project installed hardware data can be accessible by all parties for viewing only and not alterable after system has been installed. System design and connectivity data can be used to define the rules of data access.

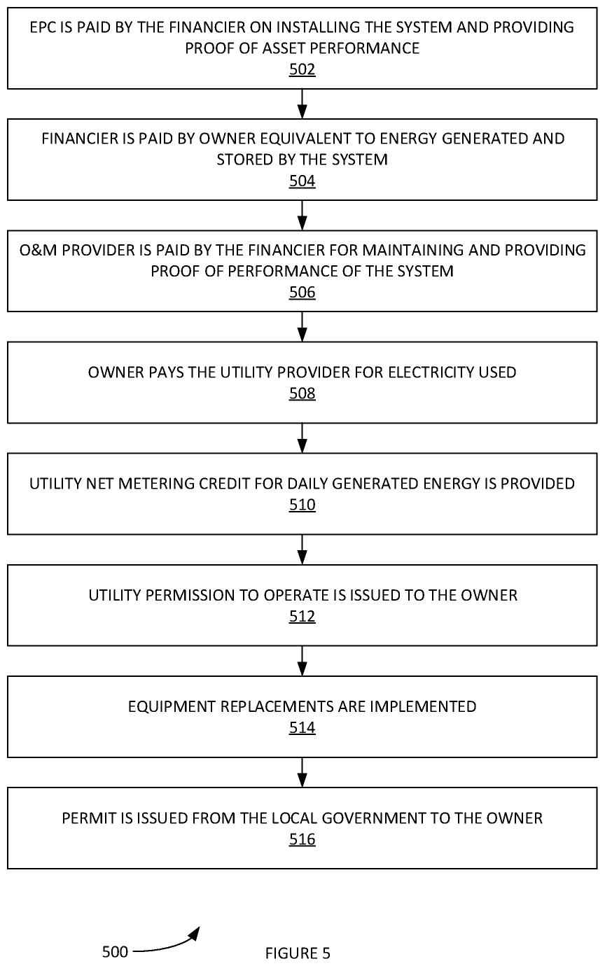

FIG. 5 illustrates an example process 500 for implementing distributed-energy-project blockchain transactions, according to some embodiments. In step 502, the EPC is paid by the financier on installing the system and providing proof of asset performance. In step 504, the financier is paid by owner equivalent to energy generated by the system. In step 506, the O&M provider is paid by the financier for maintaining and providing proof of performance of the system. In step 508, the owner pays the utility provider for electricity used. In step 508, if net metering available, the utility net metering credit for daily generated and/or stored energy is provided. In step 510, the utility rebates to the owner. In step 512, the utility permission to operate is issued to the owner. In step 514, the equipment replacements are implemented. In step 516, the permit is issued from the local government to the owner.

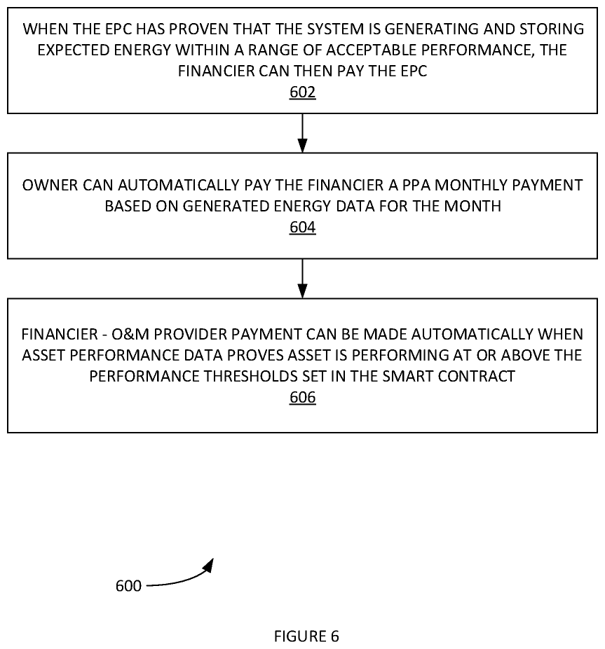

FIG. 6 illustrates an example process 600 for implementing distributed-energy-project blockchain smart contracts, according to some embodiments. EPC-Financier smart contracts can be implemented as follows. In step 602, when the EPC has proven that the system is generating and/or storing expected energy within a range of acceptable performance, the financier can then pay the EPC. This payment can be automated by verifying the generated energy data from the system.

Owner-Financier smart contracts can be implemented as follows. In step 604, the owner can automatically pay the financier a PPA monthly payment based on generated energy data for the month. In step 606, the Financier-O&M provider payment can be made automatically when asset performance data proves asset is performing at or above the performance thresholds set in the smart contract.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing distributed-energy-project blockchain transactions comprising:
providing a distributed-energy-project blockchain, wherein the distributed-energy-project blockchain records;
with the distributed-energy-project blockchain recording that an
Engineering Design, Hardware Procurement and Construction Provider (EPC) entity is paid by a financier upon installing the distributed energy system and has provided a proof of asset performance;
with the distributed-energy-project blockchain recording that the financier is paid by an owner a pecuniary equivalent to energy generated by the distributed energy system;
with the distributed-energy-project blockchain recording that an operation and maintenance (O&M) provider is paid by the financier for maintaining and providing a proof of performance of the distributed energy system;
with the distributed-energy-project blockchain recording that owner pays a utility provider for electricity used by the utility; and
with the distributed-energy-project blockchain recording that the utility provider provides a rebate to the owner.

2. The computerized method of claim 1, wherein the distributed-energy-project blockchain comprises a list of blocks.

3. The computerized method of claim 2, wherein the list of blocks are linked using a cryptographic method.

4. The computerized method of claim 3, wherein each block contains a cryptographic hash of the previous block, a timestamp, and a transaction data.

5. The computerized method of claim 4, wherein the transaction data is represented as a Merkle-tree root hash.

6. The computerized method of claim 5, wherein the distributed energy system comprises a solar energy project.

7. The computerized method of claim 6, wherein the utility provider provide a net metering service, and wherein a utility net metering credit for daily generated energy is provided by the utility provider and recorded in the distributed-energy-project blockchain.

8. The computerized method of claim 7 further comprising:
with the distributed-energy-project blockchain recording that the utility provider has provided a permission to operate that is issued to the owner.

9. The computerized method of claim 8 further comprising:
with the distributed-energy-project blockchain recording that a set of equipment replacements in the distributed energy system have been implemented.

10. The computerized method of claim 8 further comprising:
with the distributed-energy-project blockchain recording that the permit is issued from a local government to the owner.

11. A computerized method for implementing distributed-energy-project blockchain smart contracts comprising:
providing a distributed-energy-project blockchain, wherein the distributed-energy-project blockchain records a set of smart contracts, wherein the set of smart contracts include a first smart contract between an Engineering Design, Hardware Procurement and Construction Provider (EPC) and financier of a distributed energy system and a second smart contract between an operation and maintenance (O&M) provider and the financier;
determining that EPC has proven via the distributed-energy-project blockchain that the distributed energy system is generating and/or storing expected energy in a within a range of acceptable performance; and
determining, via the distributed-energy-project blockchain, that a financier distributed energy system has paid the EPC, wherein the payment is automated by verifying the generated energy data from the distributed-energy-project blockchain.

12. The computerized method of claim 11, wherein an owner of the distributed energy system automatically pays the financier a pay per action (PPA) monthly payment based on a set of generated and/or stored energy data for the month as recorded in the distributed-energy-project blockchain.

13. The computerized method of claim 12, wherein the smart contract comprises an EPC-Financier smart contract.

14. The computerized method of claim 12, wherein the Financier provides the O&M provider an automatic payment when an asset performance data as recorded in the distributed-energy-project blockchain proves asset is performing at or above the performance thresholds set in the smart contract.
